(19) United States
(12) Patent Application Publication
(10) Pub. No.: US 2007/0167141 A1
(43) Pub. Date: Jul. 19, 2007

(54) Radio communication system

(76) Inventor: Takahiko Akiyama, Tokyo (JP)

Correspondence Address: INTELLECTUAL PROPERTY / TECHNOLOGY LAW, PO BOX 14329, RESEARCH TRIANGLE PARK, NC, 27709, US

(21) Appl. No.: 11/333,480

(22) Filed: Jan. 17, 2006

(51) Int. Cl. H04M 1/00; H04B 1/38

(52) U.S. Cl. 455/90.1; 455/550.1

(57) ABSTRACT

A radio communication system has a memory for storing a channel number specifying a transceiving channel, one of a plurality of group codes allocated to each transceiving channel, an ID code which is unique to the radio communication system, and names of other radio communication systems, and a control unit for controlling voice communication with the other radio communication systems. On condition that a channel number set in a specific radio communication system having a name that is selected by a user from among the names stored in the memory is identical to the channel number stored in the memory, and that a group code set in the specific radio communication system is identical to the group code stored in the memory, the control unit performs one-to-one communication with the specific radio communication system.

### BACKGROUND

The present invention relates to a radio communication system, and more particularly to a radio communication system having a built-in direct call function.

GMRS (General Mobile Radio Service) is a communication standard for a radio communication system which uses a 467 MHz band frequency and is defined in the U.S. FCC (Federal Communications Commission) regulations.

GMRS prescribes a method of dividing a single channel into a plurality of subcodes (CTCSS/DCS), thus enabling communication between communication systems whose channels and subcodes match. CTCSS/DCS are codes defined in EIA-603. By dividing a single channel into a plurality, the number of channels can be quasi-increased, enabling effective utilization of radio wave resources.

U.S. Pat. No. 6,253,091 proposes a method of classifying communication groups according to subject matter.

### SUMMARY

An object of the present invention is to further improve the convenience of group communication using GMRS subcodes.

A radio communication system of the present invention comprises a memory for storing a channel number specifying a transceiving channel, one of a plurality of group codes allocated to each transceiving channel, an ID code which is unique to the radio communication system, and names of other radio communication systems, and a control unit for controlling voice communication with the other radio communication systems. On condition that a channel number set in a specific radio communication system having a name that is selected by a user from among the names stored in the memory is identical to the channel number stored in the memory, and that a group code set in the specific radio communication system is identical to the group code stored in the memory, the control unit performs one-to-one communication with the specific radio communication system.

### DESCRIPTION OF THE DRAWINGS

FIG. 1 is a system diagram of a transceiver according to an embodiment;

FIG. 2 is an illustrative view of an all call mode according to this embodiment;

FIG. 3 is an illustrative view of an all call command;

FIG. 4 is an illustrative view of a direct call mode according to this embodiment;

FIG. 5 is an illustrative view of a direct call command;

FIG. 6 is an illustrative view of an auto channel change mode according to this embodiment; and

FIG. 7 is an illustrative view of an auto channel change command.

### DETAILED DESCRIPTION

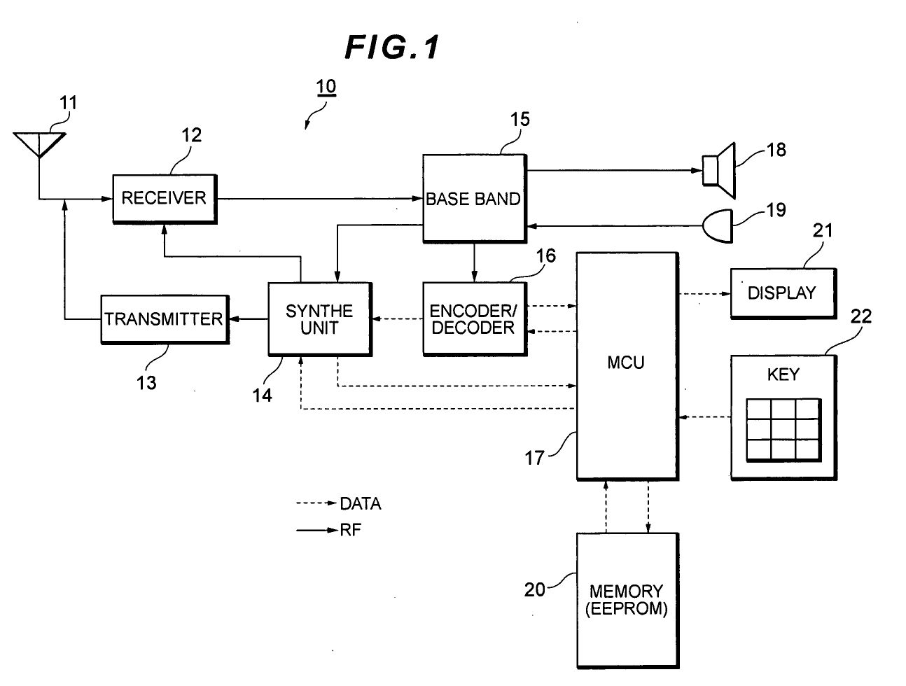

FIG. 1 shows the system configuration of a transceiver 10 according to an embodiment. The transceiver 10 is a radio communication system for performing radio communication using a simplex method (half-duplex communication), thereby enabling communication on a single channel.

The transceiver 10 has an antenna 11 for transceiving radio waves, a receiver 12 for processing received waves, a transmitter 13 for processing transmission waves, a synchronizing unit 14 for performing transmission/reception synchronization control, a base band processing portion 15 for performing base band signal processing, an encoder/decoder 16 for encoding and decoding various commands and the like superimposed on the radio waves, a micro control unit (MCU) 17 for controlling the entire system, a speaker 18 for outputting a voice, a microphone 19 for inputting a voice, memory 20 for storing various setting information (a channel number, group code, ID code, name, and so on), a display 21 for displaying the various setting information and so on, and operating keys 22 for inputting the various setting information and so on.

Next, an outline of the communication method of the transceiver 10 according to this embodiment will be described. In this embodiment, group codes obtained by expanding the subcodes defined by GMRS are used. In EIA-603, for example, a single channel is divided into 121 by 121 subcodes, whereas in this embodiment, a single channel is divided into 242 by 121 groups codes rather than the 121 subcodes.

Further, in this embodiment an ID code and name are allocated to each transceiver 10. The ID code is identification information unique to the transceiver 10, which is allocated to ensure that no plurality of transceivers share the same ID code. The name is constituted by alphabetic characters, numerals, symbols, or a combination thereof enabling easy identification of the communication partner. The name is preferably a short nickname (comprising four characters such as JOHN, BUSH, WOOD, JACK, or BABE, for example), and a plurality of transceivers may share the same name.

The memory 20 stores various setting information such as the channel number, group code, ID code, name, the ON/OFF setting of a group communication function, and so on. A user is capable of setting the channel number, group code, ID code, name, the ON/OFF setting of the group communication function, and so on by performing input on the operating keys 22. An EEPROM or the like which is capable of rewriting the various setting information is preferably employed as the memory 20.

In GMRS, when the channel numbers and subcodes set in a plurality of the transceivers 10 are respectively identical, a group communication mode enabling group communication is set. The transceivers 10 set with identical channel numbers and subcodes are referred to as group members. In this embodiment, in addition to the group communication mode, (1) an all call mode, (2) a direct call mode, and (3) an auto channel change mode are provided. Each mode will now be described.

(1) All Call Mode

In the all call mode, the transceiver 10 calls all of the group members and transmits its own ID code and name to all of the group members. The transceivers 10 receiving the call store the ID code and name of the transceiver 10 making the call in their own memories 20*.

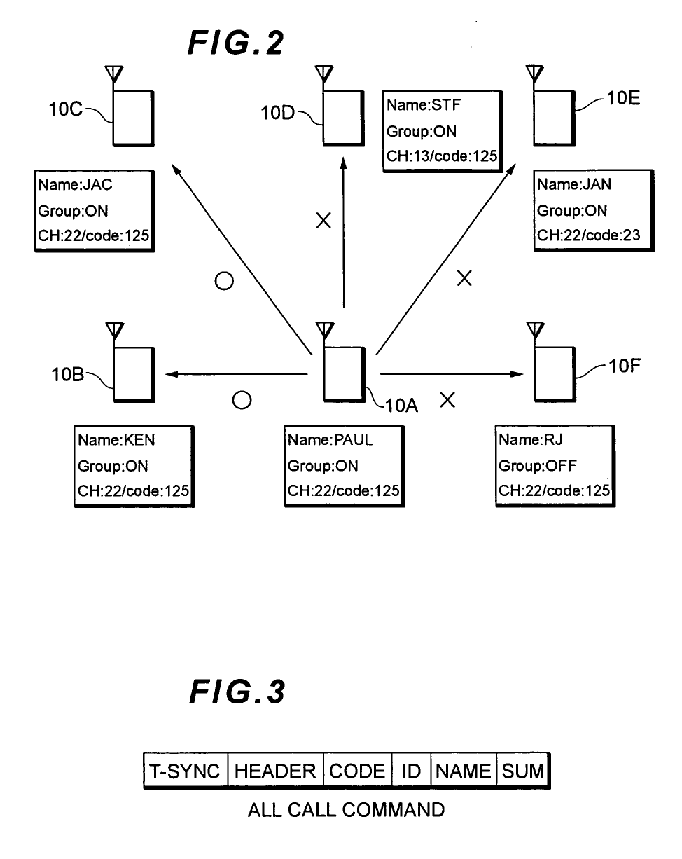

As shown in FIG. 2, for example, a transceiver 10A performs an all call by transmitting an all call command to each of transceivers 10B to 10F. As shown in FIG. 3, the all call command includes “T-SYNC” denoting a synchronization signal, “HEADER” denoting an identifier, “CODE” denoting the group code, “ID” denoting the ID code, “NAME” denoting the name, and “SUM” denoting a check sum. In relation to the example described above, the group code, ID code, and name of the transceiver 10A are stored respectively in the CODE, ID, and NAME of the all call command.

The transceiver 10A and the transceiver 10B have identical channel numbers and group codes, and are therefore related as group members. Moreover, the group communication function of both transceivers 10A, 10B is set to ON, and therefore the ID code and name of the transceiver 10A are stored in the memory 20* of the transceiver 10B.

Similarly, the transceiver 10A and the transceiver 10C have identical channel numbers and group codes, and are therefore related as group members. Moreover, the group communication function of both transceivers 10A, 10B is set to ON, and therefore the ID code and name of the transceiver 10A are stored in the memory 20* of the transceiver 10C.

However, the transceiver 10A and the transceiver 10D have different channel numbers, and therefore the transceiver 10D is unable to receive the ID code and name of the transceiver 10A.

The transceiver 10A and the transceiver 10E have different group codes, and are therefore not related as group members. Hence, the transceiver 10E rejects reception of the ID code and name of the transceiver 10A.

The group communication function of the transceiver 10F is set to OFF, and hence the transceiver 10F rejects reception of the ID code and name of the transceiver 10A.

Note that when a different name is received several times from a transceiver 10 having the same ID code, the newest name is stored in the memory 20.

Thus in the all call mode, each transceiver 10 belonging to a certain communication group transmits its own ID code and name to the other group members belonging to the same communication group, thus enabling each transceiver 10 to obtain the ID codes and names of the other group members. In other words, the group members can share their ID codes and names.

(2) Direct Call Mode

In the direct call mode, communication is performed with a single specific partner from among the group members. To perform a direct call, an all call or the like must be performed among the group members in advance so that the ID codes and names of the respective group members are shared.

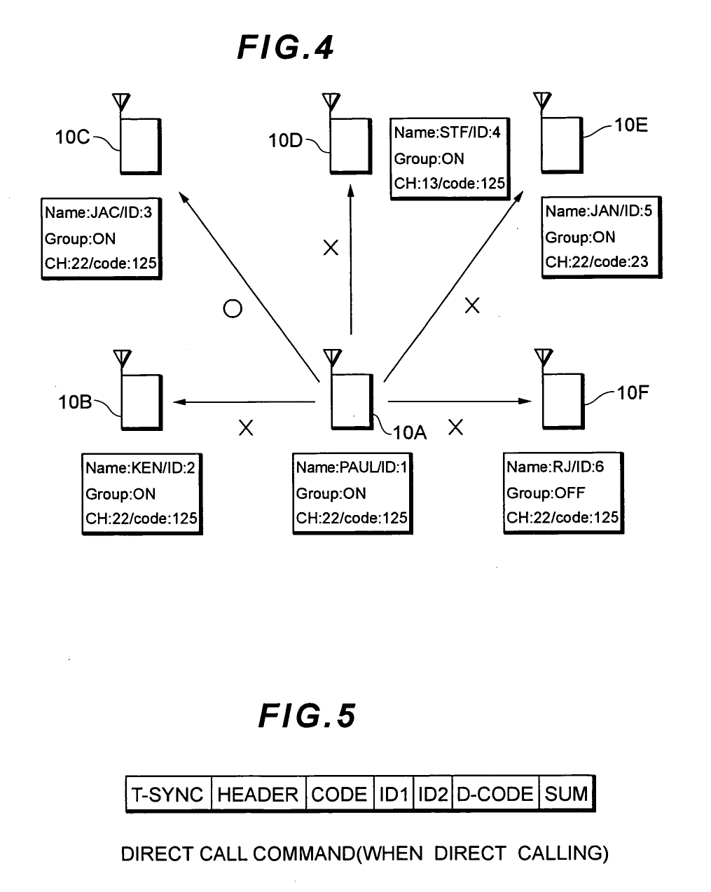

As shown in FIG. 4, for example, a direct call is made from the transceiver 10A to the transceiver 10C by selecting the name (JAC) of the transceiver 10C from an operating menu screen, and then transmitting a direct call command to the respective transceivers 10B to 10F. As shown in FIG. 5, the direct call command includes “T-SYNC” denoting a synchronization signal, “HEADER” denoting an identifier, “CODE” denoting the group code, “ID1” denoting the ID code of the call source (the terminal which makes the direct call), “ID2” denoting the ID code of the call destination (the terminal which receives the direct call), and “SUM” denoting the check sum. In relation to the example described above, the ID code “1” of the transceiver 10A is stored in the ID1 of the direct call command, and the ID code “3” of the transceiver 10C is stored in the ID2.

The transceiver 10A and the transceiver 10C have identical channel numbers and group codes, and are therefore related as group members. Moreover, the group communication function of both transceivers 10A, 10C is set to ON, and the ID2 of the direct call command matches the ID code of the transceiver 10C. Hence, the transceiver 10C receives the call made by the transceiver 10A. At this time, the name (PAUL) of the call source terminal (the transceiver 10A) is displayed on the display 21 of the transceiver 10C. When the transceiver 10C responds to the call from the transceiver 10A, one-to-one communication begins.

On the other hand, between the transceiver 10A and the transceiver 10B, the ID2 of the direct call command does not match the ID code of the transceiver 10B, and therefore the direct call from the transceiver 10A to the transceiver 10B is denied.

The transceiver 10A and the transceiver 10D have different channel numbers, and therefore a direct call cannot be made from the transceiver 10A to the transceiver 10D.

The transceiver 10A and the transceiver 10E have different group codes, and hence are not related as group members. Accordingly, the direct call from the transceiver 10A to the transceiver 10E is denied.

The group communication function of the transceiver 10F is set to OFF, and therefore the direct call from the transceiver 10A to the transceiver 10F is denied.

(3) Auto Channel Change Mode

In the auto channel change mode, the channel currently in use by the group members is changed to another channel. This mode is appropriate for use in cases such as when there is interference on the channel currently in use and it is desirable to switch to another channel with a more favorable communication environment. To change the channel currently in use by the group members, one of the group members transmits an auto channel change command requesting a channel change to the other group members. As shown in FIG. 7, the auto channel change command includes “T-SYNC” denoting a synchronization signal, “HEADER” denoting an identifier, “CODE” denoting the group code, “CH” denoting the post-change channel number, and “SUM” denoting the check sum.

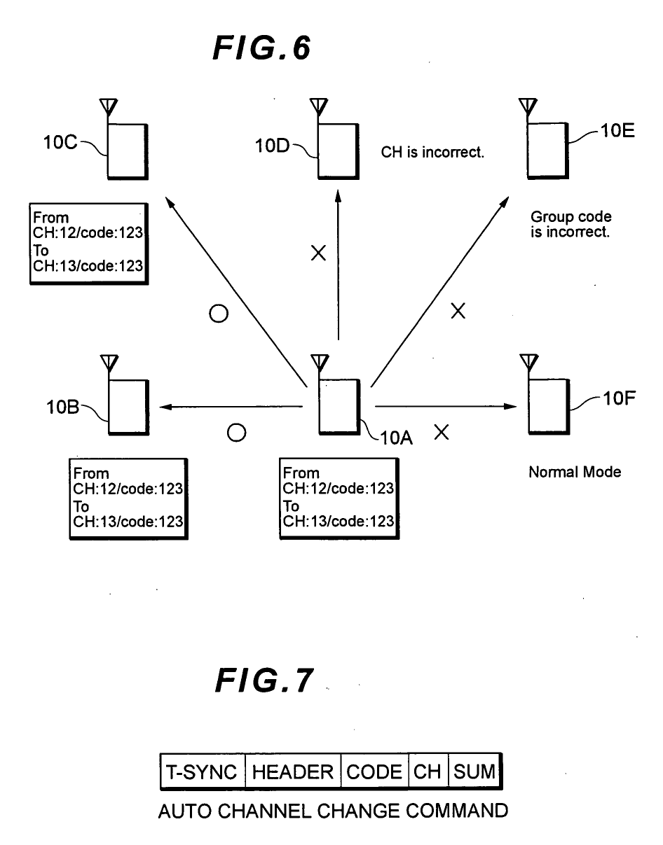

FIG. 6 shows an example in which the transceivers 10A, 10B, and 10C constitute the group members, and the transceiver 10A transmits the auto channel change command.

The transceiver 10A and the transceiver 10B have identical channel numbers and group codes, and are therefore related as group members. Moreover, the group communication function of both transceivers 10A, 10B is set to ON, and therefore the transceiver 10B receives the auto channel change command from the transceiver 10A and switches to the specified channel.

Similarly, the transceiver 10A and the transceiver 10C have identical channel numbers and group codes, and are therefore related as group members. Moreover, the group communication function of both transceivers 10A, 10C is set to ON, and therefore the transceiver 10C receives the auto channel change command from the transceiver 10A and switches to the specified channel.

On the other hand, the transceiver 10A and the transceiver 10D have different channel numbers, and are therefore not related as group members. Hence, the channel change request transmitted from the transceiver 10A to the transceiver 10D is denied.

The transceiver 10A and the transceiver 10E have different group codes, and are therefore not related as group members. Hence, the channel change request transmitted from the transceiver 10A to the transceiver 10E is denied.

The group communication function of the transceiver 10F is set to OFF, and hence the channel change request transmitted from the transceiver 10A to the transceiver 10F is denied.

Note that the transceiver 10A which transmits the channel change request automatically changes the channel after transmitting the auto channel change command.

According to this embodiment, one-to-one communication between group members and channel changing among group members are made possible by expanding the functions provided by GMRS. Moreover, a direct call can be made by specifying the name of the partner terminal, and hence convenience is improved.

We claim:

1. A radio communication system enabling a plurality of radio communication systems to perform voice communication with each other via a transceiving channel, comprising:
a memory for storing a channel number specifying said transceiving channel, one of a plurality of group codes allocated to each transceiving channel, an ID code which is unique to said radio communication system, and names of the other radio communication systems; and
a control unit for controlling said voice communication,
wherein, on condition that a channel number set in a specific radio communication system having a name that is selected by a user from among said names stored in said memory is identical to said channel number stored in said memory, and that a group code set in said specific radio communication system is identical to said group code stored in said memory, said control unit performs one-to-one communication with said specific radio communication system.

2. The radio communication system according to claim 1, wherein said control unit requests that all group members change said transceiving channel by transmitting an auto channel change command, including the channel number of a post-change transceiving channel, to all of said group members.

3. The radio communication system according to claim 1, wherein said control unit controls said voice communication using a simplex method.
